(19) United States
(12) Patent Application Publication
(10) Pub. No.: US 2005/0050306 A1
(43) Pub. Date: Mar. 3, 2005

(54) Executing instructions on a processor

(76) Inventors: Sridhar Lakshmanamurthy, Sunnyvale, CA (US); Prashant R. Chandra, Sunnyvale, CA (US); Wilson Y. Liao, Belmont, CA (US); Jeen-Yuan Miin, Palo Alto, CA (US); Yim Pun, Saratoga, CA (US); Chen-Chi Kuo, Pleasanton, CA (US); Jaroslaw J. Sydir, San Jose, CA (US); Uday R. Naik, Fremont, CA (US)

Correspondence Address: FISH & RICHARDSON, PC, 12390 EL CAMINO REAL, SAN DIEGO, CA, 92130-2081, US

(21) Appl. No.: 10/649,356

(22) Filed: Aug. 26, 2003

(51) Int. Cl. G06F 9/00

(52) U.S. Cl. 712/223

(57) ABSTRACT

A method of executing instructions on a processor includes, receiving a first condition code produced by executing a first instruction during a first clock cycle on an array of engines included in the processor, receiving a second condition code produced by executing a second instruction during a second clock cycle on the array of engines included in the processor, and executing a logical operator on the first and second condition codes during the second clock cycle on the array of engines included in the processor.

### BACKGROUND

Processors such as microprocessors, central processing units (CPU's), and the like include logic circuitry that executes instructions included in a program, subroutine, or other similar process. To execute a series of instructions included in a program, a clock provides a timing signal to execute each of the instructions in a sequential manner at a processing speed supportable by the processor. By executing a series of instructions, data such as packets of data can be received from a source, classified, and forwarded to a destination by the processor. Some processors such as network processors are designed to relatively quickly process streams of data packets received over a network such as a wide area network (WAN) and transmit the data packets through a local area network (LAN) to appropriate local destinations.

### DESCRIPTION OF DRAWINGS

FIG. 1 is a block diagram depicting a system for processing data packets.

FIG. 2 is a block diagram depicting classifying of a data packet.

FIG. 3 is a diagram depicting ALU instructions and condition codes used for classifying a data packet.

FIG. 4 is a flow chart of a portion of a packet classifier.

### DESCRIPTION

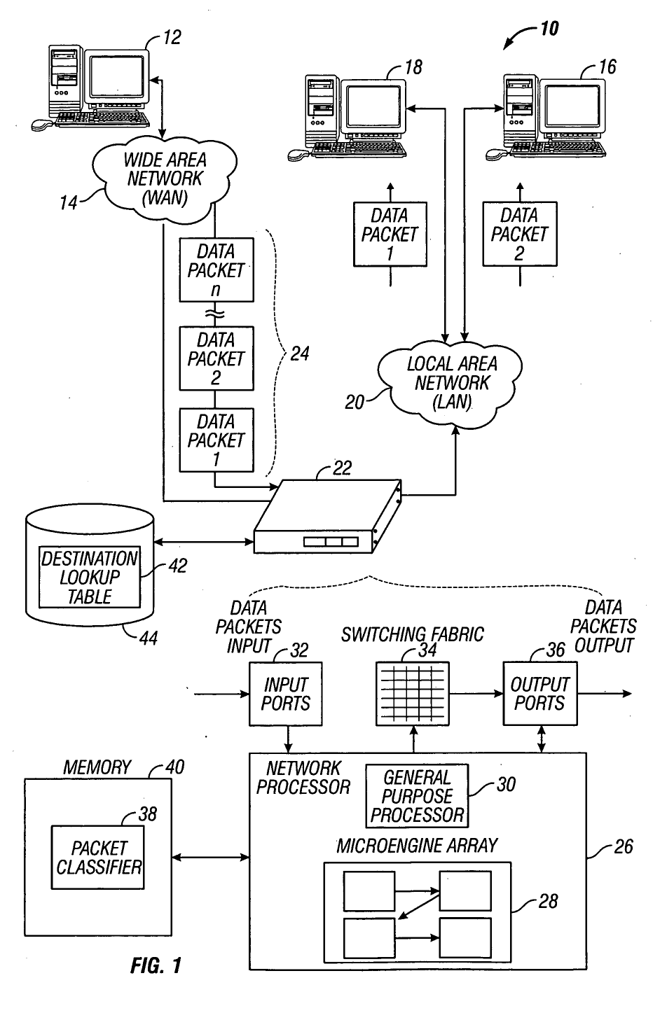

Referring to FIG. 1, a system 10 for transmitting data packets from a computer system 12 through a wide area network (WAN) 14 to other computer systems 16, 18 through a local area network (LAN) 20 includes a router 22 that collects a stream of “n” data packets 24, classifies each of the data packets, for transmission and through the LAN 20 and delivery to the appropriate destination computer system 16 or computer system 18. In this example, data packet 1 is transmitted from the computer system 12 for delivery at computer system 18 and data packet 2 is transmitted for delivery at computer system 16. To deliver the data packets to the appropriate computer system, the router 22 includes a network processor 26 that processes the data packet stream 24 with an array of, e.g., four programmable multithreaded microengines 28. Each microengine executes instructions that are associated with an instruction set (e.g., a reduced instruction set computer (RISC) architecture) used by the array of microengines 28 included in the network processor 26. Since the instruction set is designed for specific use by the array of microengines 28, instructions are processed relatively quickly compared to the number clock cycles typically needed to execute instructions associated with a general-purpose processor.

Each one of the microengines included in the array of microengines 28 has a relatively simple architecture and quickly executes relatively routine processes (e.g., data packet classifying, data packet forwarding, data packet converting, etc.) while leaving more complicated processing (e.g., look-up table maintenance) to other processing units such as a general-purpose processor 30 (e.g., a StrongArm processor of ARM Limited, United Kingdom) also included in the network processor 26.

Typically the data packets are received by the router 22 on one or more input ports 32 that provide a physical link to the WAN 14 and are passed to the network processor 26 that controls the entering of the incoming data packets. Typically the network processor 26 processes (e.g., determines the destination of each data packet) and passes the data packets to a switching fabric 34 that connects to output ports 36. However, in some arrangements the router 22 does not include the switching fabric 34 and the network processor 26 directs the data packets to the output ports 36. The output ports 36, which are also in communication with the network processor 26, are used for scheduling transmission of the data packets to the LAN 20 for reception at the appropriate computer system 16 or 18.

To schedule the transmission of the data packets, the network processor 26 determines one or more destinations (e.g., computer system 16, 18, etc.) to send each of the data packets. To determine the appropriate destinations, a packet classifier 38 that resides in a memory 40 (e.g., RAM, SRAM, DRAM, etc.), which is in communication with the network processor 26, is executed by the array of microengines 28 included in the network processor 26. To direct the data packet to the appropriate destination, the packet classifier 38 compares data stored in the received data packet to data stored in a destination lookup table 42 that is stored on a storage device 44 (e.g., hard drive, CD-ROM, etc.) in communication with the router 22 by hardwire or other connection scheme (e.g., Internet, wireless connection, etc.). Also, in some arrangements, the destination lookup table 42 resides in memory 40 or another memory in communication with the network processor 26 that is relatively quickly accessible.

By determining a match from the data comparison, the data provided by the destination lookup table 42 indicates one or more destinations for the data packet. In this particular example, data stored in data packet 1 matches with data stored in the destination lookup table 42 to indicate that data packet 1 is to be transmitted to computer system 18. Also, in this example, a match between data stored in data packet 2 and data stored in the destination lookup table 42 indicates that data packet 2 be transmitted to computer system 16.

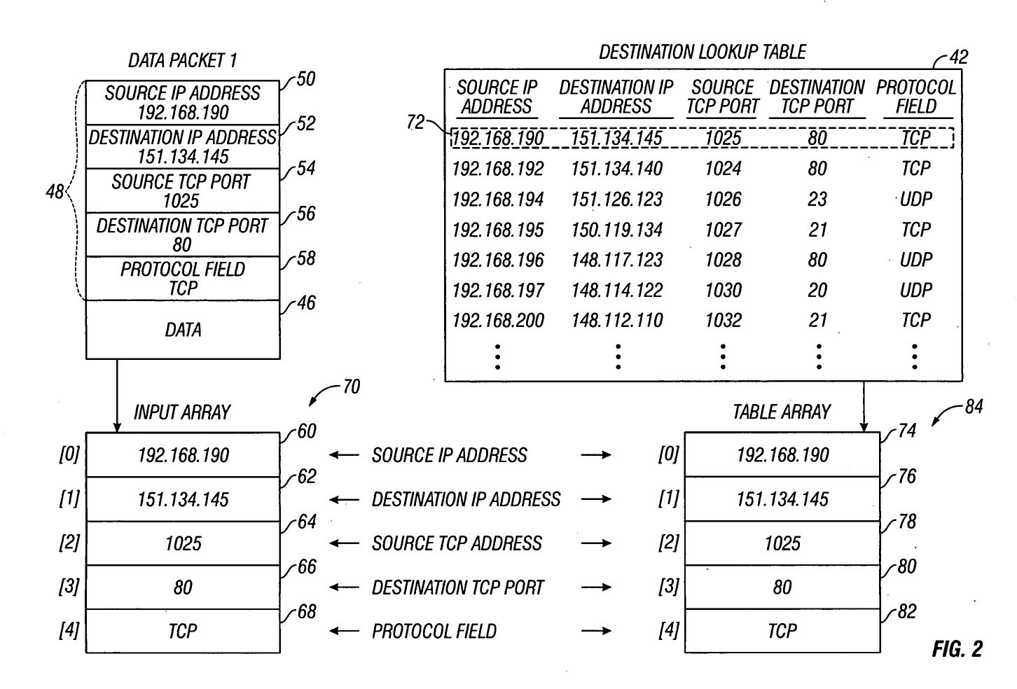

Referring to FIG. 2, data packet 1 includes data 46 and a header 48 that includes information that is compared to data stored in the destination lookup table 42 to determine the one or more destinations of the data packet 1. In some arrangements, the packet classifier 38 uses information stored in five fields 50-58 included in the header 48 to classify the data packet 1 for delivery. In this example the five fields 50-58 include a source Internet Protocol (IP) address 50, a destination IP address 52, a source Transmission Control Protocol (TCP) port 54, a destination TCP port 56, and a protocol field 58. The source IP address field 50 includes data that identifies the source (e.g., computer system 12) that transmitted data packet 1 to the router 22 and the destination IP address 52 provides data that indicates the destination of the data packet.

Typically the destination IP address is used to deliver the data packet to the appropriate one or more destinations, however, during delivery, data packets may be transmitted across different pathways of the LAN 20 and arrive at the destination out of order. To reorder the data packets, another protocol, such as the transmission control protocol (TCP) is used to include data in each data packet to properly reorder the packets. TCP is a connection-oriented protocol that keeps track of the sequence of the data packets and is used for transferring streams of data packets. By reordering the packets, TCP provides reliability, efficient flow control, full-duplex operation, and multiplexing capabilities to data packet delivery while also allowing devices to deal with lost, delayed, duplicate, or misread packets.

The source TCP port 54 and the destination TCP port 56 fields included in the header 48 respectively identify upper-layer source and destination processes that send and are scheduled to receive TCP services. For example, typically TCP port number “80” is used to indicate that the source or destination is a web site (e.g., an http address) or, in another example, TCP port number “20” typically indicates that the source or destination port is using a file transfer protocol (FTP). The protocol field 58 identifies the particular protocol used by the data packet such as TCP or User Datagram Protocol (UDP), which is typically used for real-time data streaming e.g., for Internet radio or online gaming where dropped packets are generally not resent due to excessive retransmission time delay.

In this example, to determine the destination of data packet 1, the data stored in the five fields 50-58 of the header 48 is retrieved by the packet classifier 38 and entered into five respective elements 60-68 of an input array 70 for comparing the individual elements to data retrieved from the destination lookup table 42. In this particular example the destination lookup table 42 includes lists of data that correspond to the five fields of the header 48. By retrieving a row of data from the lookup destination table 42, as highlighted by dashed-line box 72, and entering the data into respective elements 74-82 of a table array 84, the packet classifier 38 compares respective pairs of elements in the input array 70 and the table array 84 to determine if there is a match for indicating the destination of data packet 1. After comparing the data in the input array 70 and the table array 74, the packet classifier 38 retrieves the next row of data from the destination lookup table 42 for entering in the table array 84 to determine other potential matches that indicate other destinations to send data packet 1. In this particular arrangement to determine a destination, the five fields 50-58 included in the header 48 were retrieved and compared to data in the destination lookup table 42. However, in some arrangements the packet classifier 38 uses additional fields included in the header 48 or less than five fields to determine the one or more destinations of the data packet 1.

In this particular example element 60 (i.e., Input Array[0]) of input array 70 stores the data (i.e., 192.168.190) included in the source IP address field 50 of the header 48. Element 62 (i.e., Input Array[1]) stores the data (i.e., 151.134.145) included in the destination IP address field 52, element 64 (i.e., Input Array[2]) stores the data (i.e., 1025) included in the source TCP port field 54, element 66 (i.e., Input Array[3]) stores the data (i.e., 80) included in the destination TCP port field 56, and element 68 (i.e., Input Array[4]) stores the data (i.e., TCP) included in the protocol field 58.

To determine the destination of data packet 1, the packet classifier 38 attempts to match the data stored in the input array 70 with data stored in the destination look-up table 42. In this particular example, the table array 84 stores the data from the destination look-up table 42 that is highlighted by the dashed-line box 72. The table array 84 stores in element 74 (i.e., Table Array[0]) the source IP address (i.e., 192.168.190) entered from the highlighted selection 72. The destination IP address (i.e., 151.134.145) is entered into element 76 (i.e., Table Array [1]), the source TCP port (i.e., 1025) is entered into element 78 (i.e., Table Array [2]), the destination TCP port (i.e., 80) is entered into element 80 (i.e., Table Array [3]), and the protocol field (i.e., TCP) is entered into element 82 (i.e., Table Array [4]). By comparing the respective pairs of elements 60-68 of the input array 70 and the elements 74-82 of the table array 84, the packet classifier 38 identifies the matching data and determines a destination for data packet 1.

To compare the data in the input array 70 and the table array 84, the microengine array 28 executes, for example, a series of arithmetic-logic unit (ALU) instructions included in the packet classifier 38. For example, a series of five ALU instructions compares data stored in each of the five pairs of array elements to determine if the data matches. For example, the input array 70 element 60 (i.e., Input Array [0]) is compared to the table array 84 element 74 (i.e., Table Array[0]) to determine if the data stored in each element matches. Accordingly, the other corresponding pairs of input array 70 elements and table array 84 elements are compared for matches. To determine a destination for the router 22 to send data packet 1, each of the five pairs of elements of the input array 70 and the table array 84 need to match. However, in other arrangements, more or less matches are needed to determine a destination.

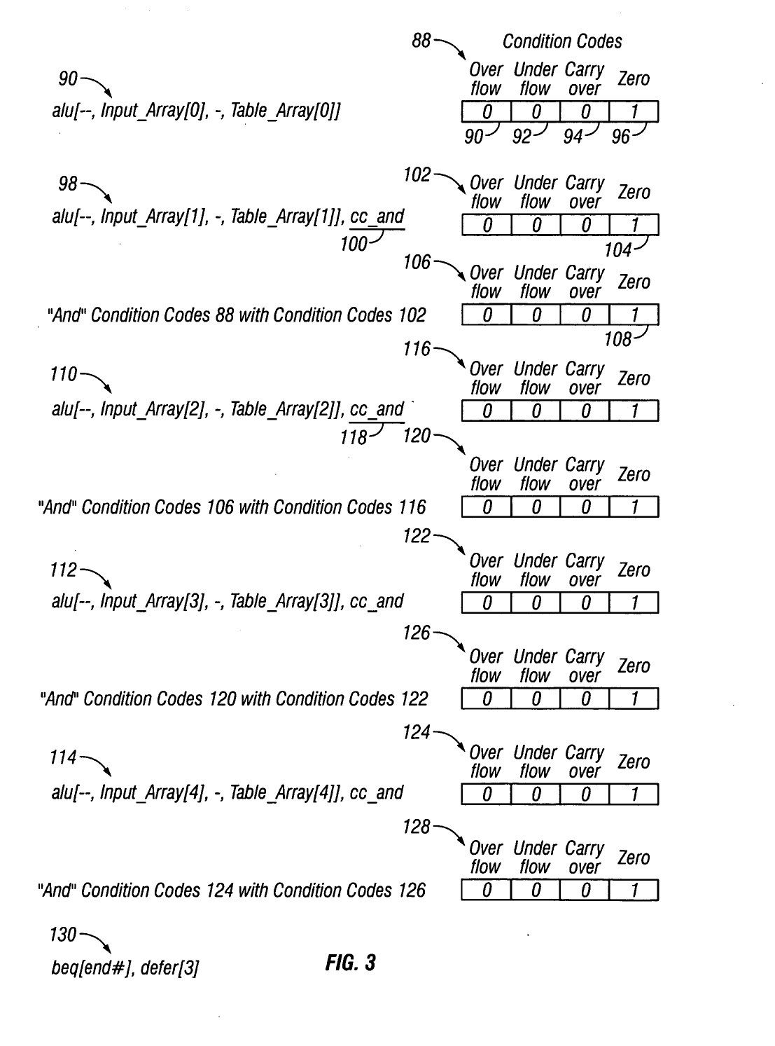

Referring to FIG. 3, to compare each pair of array elements, a series of ALU instructions are executed, e.g., to subtract the data stored in one array element (e.g., Input Array[0]) from the data stored in the other corresponding array element (e.g., Table Array[0]) of the pair so that a match produces a numerical zero result from the subtraction. In this example, ALU instruction 86 subtracts table array 84 element 74 (i.e., Table Array [0]) from input array 70 element 60 (i.e., Input Array [0]). Based on the execution of the ALU instruction 86, a group of binary flags (i.e., condition codes) that are typically stored in a condition code register 88 included in the network processor 26, are set to store a logic value of “1” or “0” based on the result of the subtraction.

In this arrangement, four condition codes are set by each executed ALU instruction. An overflow condition code 90 included in the condition code register 88 is set to a logic value “1” if the executed ALU instruction 86 produces an overflow (e.g., instruction result exceeds length of register used to execute instruction). An underflow condition code 92 is set to a logic value “1” if the executed ALU instruction 86 produces an underflow (e.g., produces a non-zero result that is too small to stored in the register used to execute the instruction). A carry over condition code 94 is set to a logic value of “1” if the executed ALU instruction 86 produces a carry over (e.g., borrowing occurs during a execution of the subtraction) and a zero condition code 96 is set to a logic value of “1” if the ALU instruction 86 produces numerical value of zero. In some arrangements the condition code register 88 includes additional condition codes, less condition codes, or replaces one or more of the condition codes stored in the register.

By setting the condition codes during execution of each ALU instruction 86, one or more of the condition codes are capable of being used as input data to one or more additional ALU instructions. For example, during one clock cycle an ALU instruction is executed by the microengine array 28 and the condition codes are set. During the next clock cycle another ALU instruction is executed that accordingly also sets condition codes. Additionally, during the second clock cycle, a logic operator is applied to the condition codes associated with the previous ALU instruction and the condition codes associated with the second ALU instruction. So during the two clock cycles, three operations are executed: execution of the first ALU instruction, execution of the second ALU instruction, and applying a logical operation to the two sets of condition codes. By executing these three operations in two clock cycles, a third clock cycle is conserved for executing other instructions or for other processing. Additionally, by conserving a clock cycle, power consumption of the network processor 26 is also reduced.

In this particular example ALU instruction 86 is executed by a microengine in the microengine array 28 during one clock cycle and since both array elements (i.e., Input Array[0] and Table Array[0]) are equivalent, the zero condition code 96 is set to logic “1” to indicate a numerical zero result from the subtraction. During the next clock cycle the microengine array 28 executes ALU instruction 98 that subtracts the second elements of the Input Array 70 and the Table Array 84 to determine if there is a match. The ALU instruction 98 also includes and applies an “AND” logical operator 100 to the condition codes included in register 88, which were set by the ALU instruction 86, and condition codes 102 set by the execution of the ALU instruction 98. Here, zero condition code 96 is set to a logic “1” value, which indicates the first array elements (i.e., input array [0] and table array [0]) are equivalent, and zero condition code 104 is set to a logic “1” value, which indicates the second element of both arrays (i.e., input array [1] and table array [1]) are equivalent. By applying the “AND” operator 100 to the condition codes 88 and 102, condition codes 106 are produced and include a logic “1” value for zero condition code 108 that represents the result of applying the “AND” operator to zero condition code 96 and 104. The overflow, underflow, and carry over of the condition codes 106 are set to logic “0” since the corresponding values in condition codes 88 and 102 are set to logic “0” values when the “AND” logical operator 100 is applied.

So during two clock cycles both ALU instructions 86 and 98 are executed by the microengine array 28 along with the “AND” logical operator 100 that produces the zero condition code 108 set to logic “1” to indicate that both element pairs (i.e., Input Array [0] Table Array [0], and Input Array [1] Table Array [1]) are equivalent. During the next three clock cycles the microengine array 28 respectively executes three ALU instructions 110, 112, and 114 to determine if the corresponding element pairs of the input array 70 and the table array 84 match. For example, ALU instruction 110 determines if the third element of the input array 70 (i.e., element 64) and the third element of the table array 84 (i.e., element 78) match. Similar to ALU instruction 98, each of the ALU instructions 100, 112, and 114 include an “AND” logical operator that is applied to the condition codes set by the ALU instruction and the condition codes produced from the previous ALU instruction. For example, executing ALU instruction 110 sets condition codes 116 that are applied to the condition codes 106 with the “AND” operator 118 to produce the condition codes 120. Similarly, ALU instruction 112 and 114 each respectively execute during one clock cycle to set respective condition codes 122 and 124 and apply a logical “AND” operator to produce the respective condition codes 126 and 128. Since each of the of the corresponding element pairs of the input array 70 and the table array 84 are equivalent, the zero condition code of condition codes 122 and 124 are set to a logic “1” value and accordingly when the logical “AND” operator is applied, the respective zero condition codes included in the condition codes 126 and 128 produce a logic “1” value. After the condition codes 128 are produced, a branch instruction 130 uses the zero condition code included in the condition codes 128 as a single indication if the elements 60-68 of the input array 70 matched the respective elements 74-82 of the table array 84. In this particular example, the respective elements do match and the data packet 1 is scheduled for transmission to the appropriate destination by the router 22.

So each of the ALU instructions 98, 110, 112, 114 executes a subtraction operation and applies a logical “AND” operator to condition codes in one respective clock cycle. By performing both operations in one clock cycle, at least a second clock cycle is conserved by each of these ALU instructions. Since each of the ALU instructions 98, 110, 112, 114 conserve at least an additional clock cycle, in aggregate, the packet classifier 38 conserves at least 4 clock cycles in determining one destination of the data packet 1.

In this particular example, a logical “AND” operator (i.e., cc_and) was included in each of the ALU instructions 98, 110, 112, 114. In some arrangements, other logical operations are capable of being included in one or more ALU instructions. For example, instead of using an “AND” logical operator, an ALU instruction includes an “OR” logical operator to indicate that a logical “OR” operation be applied to the condition codes set by the execution of the ALU instruction and to condition codes set by a previously executed ALU instruction. In some arrangements other logical operators are used by one or more ALU instructions. For example, “NOR”, “NAND”, “Exclusive OR”, Exclusive NOR”, or other similar logical operators are used individually or in combination.

Also, in this particular example, a logical operator is applied to condition codes set by the execution of an ALU instruction (e.g., ALU instruction 98) and to other condition codes set by another ALU instruction (e.g., ALU instruction 86) executed during the previous clock cycle. However, in some arrangements along with using condition codes produced from the currently executed ALU instruction and condition codes produced from one previously executed ALU instruction, a logical operator is also applied to condition codes produced from one or more additional ALU instructions previously executed. Also, in this particular example, the logical operator is applied to all of the condition codes produced by the execution of an ALU instruction. However, in some arrangements the logical operator is applied to one type of condition code (e.g., the zero condition codes), or only two or more types of condition codes (e.g., the zero condition codes and the carryover condition codes).

Along with using logical operators, an ALU instruction can include a logical operator that disregards condition codes produced by a previously executed instruction or that disregards condition codes produced by the currently executed instruction. One exemplary ALU instruction is:
ALU[destination, a_operand, alu_op, b_operand], cc_IGNORE (1)

ALU instruction (1) includes a logical operator (i.e., cc_IGNORE) that preserves the condition codes set by a previously executed ALU instruction and ignores the values of the condition codes set by the currently executed ALU instruction (1).

By retaining previously set condition codes and disregarding condition codes set by later executed instructions, the condition codes are preserved for later use while the microengine array 28 executes one or more instructions prior to an instruction that uses the previously set condition code. For example, the microengine array 28 executes ALU instruction (2) during one clock cycle and sets the condition codes:
ALU[-, a_value, -, b_value] (2)

Next, two unrelated ALU instructions are executed that each include the “Ignore” logical operator so that the condition codes produced by ALU instructions (3) and (4) are disregarded and the condition codes produced by ALU instruction (2) are preserved.
ALU[-, c_value, -, d_value], CC_IGNORE (3)
ALU[-, d_value, -, e_value], CC_IGNORE (4)

Since the condition codes produced by ALU instructions (3) and (4) were disregarded, the condition codes set by ALU instruction (2) capable of being used in the next ALU instruction:
Bne(not_zero), defer (2) (5)

In this example ALU instruction (5) is a branch instruction that uses the condition codes produced by ALU instruction (2) to determine whether or not to branch. So in this particular example, two clock cycles are conserved since ALU instructions (3) and (4) each execute in one clock cycle prior to the execution of the branch instruction (5) which uses the condition codes set by the execution of ALU instruction (2).

In some arrangements an ALU instruction executed by the microengine array 28 includes a logical operator so that previously set condition codes are disregarded and the condition codes set by the executing ALU instruction are preserved. For example, such an ALU instruction is:
ALU[destination, a_operand, alu_op, b_operand], cc_SET (6)

This example ALU instruction includes a logical operator (i.e., cc_SET) that disregards condition codes set by a previously executed ALU instruction and retains the condition codes set by the currently executed ALU instruction (6).

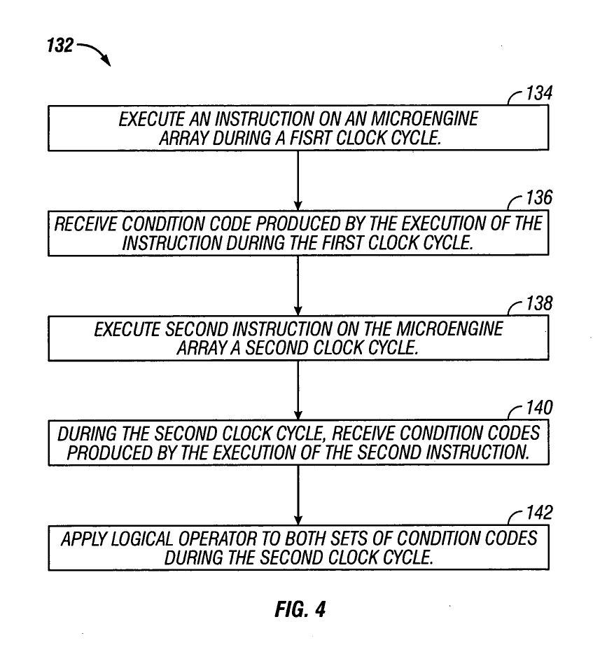

Referring to FIG. 4, a packet classifier 132 or other similar process executed by the microengine array 28 in the network processor 26 includes executing 134 one instruction such as an ALU instruction (e.g., ALU instruction 86, etc.) on a microengine during a first clock cycle or other similar time period and receiving 136 condition codes produced by the execution of instruction during the first clock cycle. After the condition codes are received 136, packet classifier 132 executes 138 a second instruction (e.g., an ALU instruction, etc.) on microengine array 28. The second instruction is executed during another time period such as the next clock cycle after the execution of the first instruction. During execution 138, a second set of condition codes are received 140 based on the executed second instruction during the second clock cycle.

After receiving 136 the condition codes produced by the execution of the first instruction and after receiving 140 the condition codes produced by the execution of the second instruction, the packet classifier 132 applies 142 a logical operator to the two sets of condition codes during the second clock cycle. For example, the packet classifier 132 applies a logical “AND” operator, a logical “OR” operator, or other similar logical operator (e.g., “NAND”, “Exclusive OR”, etc.) to both sets of condition codes. Furthermore, in some arrangements the logical operator disregards one set of condition codes and preserves the other set of condition codes for use during the execution of the second instruction or another instruction. For example the condition codes produced by the execution of the first instruction can be preserved (i.e., apply an IGNORE operator) and the second set of condition codes are disregarded. Alternatively, the first set of condition codes is disregarded (e.g., apply a SET operator) and the second set of condition codes are preserved.

The packet classifier 132 described herein can be implemented in digital electronic circuitry, or in computer hardware, firmware, software, or in combinations of them. The packet classifier 132 described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Particular embodiments have been described, however other embodiments are within the scope of the following claims. For example, the operations of the packet classifier 132 can be performed in a different order and still achieve desirable results.

1. A method of executing instructions on a processor, the method comprising:
receiving a first condition code produced by executing a first instruction during a first clock cycle on an array of engines included in the processor;
receiving a second condition code produced by executing a second instruction during a second clock cycle on the array of engines included in the processor; and
executing a logical operator on the first and second condition codes during the second clock cycle on the array of engines included in the processor.

2. The method of claim 1, wherein executing the logical operator includes executing a logical “AND” operation.

3. The method of claim 1, wherein executing the logical operator includes ignoring the first condition code.

4. The method of claim 1, wherein executing the logical operator includes ignoring the second condition code.

5. The method of claim 1, wherein the first instruction is executed on one engine within the array of engines included in the processor.

6. The method of claim 1, wherein the first condition code indicates if the execution of the first instruction produced a numerical zero.

7. The method of claim 1, wherein the first condition code indicates if the execution of the first instruction produced an overflow.

8. The method of claim 1, wherein the first condition code includes data for determining a destination of a data packet.

9. The method of claim 1, wherein a third instruction is executed by the array of engines prior to executing the second instruction.

10. A computer program product, tangibly embodied in an information carrier, for executing instructions on a processor, the computer program product being operable to cause a machine to:
receive a first condition code produced by executing a first instruction during a first clock cycle on an array of engines included in the processor;
receive a second condition code produced by executing a second instruction during a second clock cycle on the array of engines included in the processor; and
execute a logical operator on the first and second condition codes during the second clock cycle on the array of engines included in the processor.

11. The computer program product of claim 10, wherein executing the logical operator includes executing a logical “AND” operation.

12. The computer program product of claim 10, wherein executing the logical operator includes ignoring the first condition code.

13. The computer program product of claim 10, wherein executing the logical operator includes ignoring the second condition code.

14. The computer program product of claim 10, wherein the first instruction is executed on one engine within the array of engines included in the processor.

15. The computer program product of claim 10, wherein the first condition code indicates if the execution of the first instruction produced a numerical zero.

16. The computer program product of claim 10, wherein the first condition code indicates if the execution of the first instruction produced an overflow.

17. The computer program product of claim 10, wherein the first condition code includes data for determining a destination of a data packet.

18. The computer program product of claim 10, wherein a third instruction is executed by the array of engines prior to executing the second instruction.

19. A packet classifier comprises:
a process to receive a first condition code produced by executing a first instruction during a first clock cycle on an array of engines included in a processor;
a process to receive a second condition code produced by executing a second instruction during a second clock cycle on the array of engines included in the processor; and
a process to execute a logical operator on the first and second condition codes during the second clock cycle on the array of engines included in the processor.

20. The packet classifier of claim 19, wherein executing the logical operator includes executing a logical “AND” operation to determine a destination for a packet.

21. The packet classifier of claim 19, wherein executing the logical operator includes ignoring the first condition code.

22. The packet classifier of claim 19, wherein executing the logical operator includes ignoring the second condition code.

23. The packet classifier of claim 19, wherein the first instruction is executed on one engine within the array of engines included in the processor.

24. The packet classifier of claim 19, wherein the first condition code indicates if the execution of the first instruction produced a numerical zero.

25. The packet classifier of claim 19, wherein the first condition code indicates if the execution of the first instruction produced an overflow.

26. The packet classifier of claim 19, wherein the first condition code indicates if the execution of the first instruction produced an overflow.

27. The packet classifier of claim 19, wherein a third instruction is executed by the array of engines prior to executing the second instruction.

28. A system comprising a processor capable of:
receiving a first condition code produced by executing a first instruction during a first clock cycle on an array of engines included in the processor;
receiving a second condition code produced by executing a second instruction during a second clock cycle on the array of engines included in the processor; and
executing a logical operator on the first and second condition codes during the second clock cycle on the array of engines included in the processor.

29. The system of claim 28, wherein executing the logical operator includes executing a logical “AND” operation.

30. The system of claim 28, wherein executing the logical operator includes ignoring the first condition code.

31. A system comprising:
a router including an input port for receiving data packets and an output port for data packet delivering as determined by a switch fabric; and
a processor capable of,
receiving a first condition code produced by executing a first instruction during a first clock cycle on an array of engines included in the processor,
receiving a second condition code produced by executing a second instruction during a second clock cycle on the array of engines included in the processor, and
executing a logical operator on the first and second condition codes during the second clock cycle on the array of engines included in the processor.

32. The system of claim 31, wherein executing the logical operator includes executing a logical “AND” operation.

33. The system of claim 31, wherein executing the logical operator includes ignoring the first condition code.

34. A processor comprising:
an engine having an instruction set including an instruction having a syntax that specifies a logical operation on a condition code determined by executing the instruction and on another condition code determined from a previously executed instruction.

35. The processor of claim 34, wherein the processor includes a second engine.

36. The processor of claim 34, wherein the engine is multithreaded.
